(19) United States
(12) Patent Application Publication
(10) Pub. No.: US 2008/0050946 A1
(43) Pub. Date: Feb. 28, 2008

(54) Press-fit contact

(76) Inventors: Chiharu Nunokawa, Tokyo (JP); Satoshi Iijima, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/892,370

(22) Filed: Aug. 22, 2007

(30) Foreign Application Priority Data
Aug. 25, 2006 (JP) 2006-229060

(51) Int. Cl. H01R 12/34

(52) U.S. Cl. 439/82; 439/78

(57) ABSTRACT

To prevent damage to a printed circuit board due to concentration of contact pressure during press-fitting of press-fit contacts into through-holes of the board with narrow pitches, a press-fit contact includes a bulge portion formed wide substantially at a center in a long direction thereof, a press-fit portion extending from one end of the bulge portion and projecting in an arc in a width direction of the press-fit contact, a contact portion extending from other end of the bulge portion, and an introduction portion extending from a distal end of the press-fit portion, wherein a center portion of the press-fit portion in the long direction thereof, when adjacent press-fit contacts are provided in alignment with a line, having a direction of expansion that is not parallel to the line but is angled so as to be rotated about an axis of the center portion at a predetermined angle.

### BACKGROUND OF THE INVENTION

1. Field of the Invention

The present invention relates to a press-fit contact in which press-fitting into a through-hole of a printed circuit board effects an electrical connection.

2. Related Art

Conventionally, for a connector that is to be mounted on a printed circuit board, contacts for electrical conduction to a circuit in the printed circuit board are provided and fixed in place by soldering. However, in recent years, from the viewpoint of solder-free connection or operating efficiency, connectors using press-fit contacts have come to be used.

Such a press-fit contact 10, as shown in FIGS. 7A, 7B, and 7C, is punched out of a sheet of material, and includes an introduction portion 10a for introducing the contact 10 into a through-hole 11a of a printed circuit board 11, a press-fit portion 10b, an expanded portion 10c, and a contact portion 10d. The press-fit portion 10b is formed between the expanded portion 10c and the introduction portion 10a, and like a sewing needle, configured by arc portions 10e projecting along both sides in the shape of an arc so as to form an elliptical slit 10f at the center portion as well as form its edge portions. As shown in FIG. 8, the expanded portion 10c is fitted and fixed in a fixing hole 12a of an insulating housing 12 made of synthetic resin (for example, see JP-A-2005-158507).

Multiple press-fit contacts 10 fitted in the insulating housing 12 are press-fitted into through-holes 11a of the printed circuit board 11 respectively. The arc portions 10e of the press-fit portions 10b of the press-fit contacts 10 are compressed and deformed so that the reaction force causes the arc portions 10e to press against the walls of the through-holes 11 and effecting a secure electrical connection.

However, in the conventional press-fit contact 10, as shown in FIG. 7C, the press-fit portions 10b of adjacent press-fit contacts 10, 10 are arranged in alignment in a direction of expansion of the press-fit portion 10b projecting in the shape of an arc means. Accordingly, the through-holes 11a of the printed circuit board 11 are also arranged in alignment in the same direction. Therefore, when press-fit contacts 10 to be mounted in a high-density manner are arranged with their pitches narrowed, the pitches between the through-holes 11a are also brought into close proximity with each other, and as the result, contact pressure in the press-fitting of the press-fit portions 10b generates simultaneously and concentrates between the through-holes 11a, 11a, causing strain within the board and causing glass fibers of the board to peel.

### SUMMARY OF THE INVENTION

As described above, the printed circuit board 11 is likely to be damaged. Consequently, a press-fit contact according to the present invention is proposed in order to solve the problem of the conventional art described above.

In order to solve the problem described above, a press-fit contact according to the present invention comprises a bulge portion formed wide substantially at a center in a long direction of the press-fit contact, a press-fit portion extending from one end of the bulge portion and projecting in an arc in a width direction of the press-fit contact, a contact portion extending from other end of the bulge portion, and an introduction portion extending from a distal end of the press-fit portion, wherein a center portion of the press-fit portion in the long direction thereof, when adjacent press-fit contacts are provided in alignment with a line, having a direction of expansion that is not parallel to the line but is angled so as to be rotated about an axis of the center portion at a predetermined angle.

The angle of the press-fit portion may be formed by twisting the bulge portion, and may also be formed by twisting the press-fit portion itself. In the case of twisting the bulge portion, the formation of a constricted portion with a vertical center thinned makes twisting easy, and is thus preferable. When multiple rows of through-holes are formed vertically and horizontally, it is most preferable that the rotation angle of the press-fit portion be approximately 45 degrees, because doing so gives the spaces between adjacent through-holes their largest values either from the vertical or the horizontal, and will not concentrate contact pressure due to press-fitting of the press-fit portions.

According to the press-fit contact of the present invention, the concentration of contact pressure between the through-holes of the printed circuit board by the press-fit portions of the press-fit contacts is eliminated, thereby enabling damage to the board to be avoided.

In addition, in order to rotate the expansion direction of the press-fit portion, two ways of twisting any of the expanded portion and the press-fit portion itself can be employed, which increases options for the manufacturing method.

Other objects, features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1A shows a perspective view of a press-fit contact according to a first embodiment of the present invention;

FIG. 1B shows a front view of press-fit contacts according to the first embodiment, which are arranged in a line;

FIG. 1C shows a sectional view along a line 1C-1C in FIG. 1B;

FIG. 2A shows a perspective view of a press-fit contact according to a second embodiment of the present invention;

FIG. 2B shows a front view of press-fit contacts according to the second embodiment, which are arranged in a line;

FIGS. 3A to 3C respectively show sectional views along lines 3A-3A, 3B-3B, and 3C-3C in FIG. 2B;

FIG. 4 shows an illustration of arrangement of press-fit contacts according to the present invention for sections of expanded-portions of press-fit portions;

FIG. 5 shows a sectional view for a method of mounting press-fit contacts according to the present invention into through-holes of a printed circuit board with use of a jig;

FIG. 6 shows a perspective view for the mounting method of the press-fit contacts;

FIG. 7A shows a perspective view of a conventional press-fit contact;

FIG. 7B shows a front view of conventional press-fit contacts arranged in a line;

FIG. 7C shows a sectional view along a line 7C-7C in FIG. 7B; and

FIG. 8 shows a perspective view of the press-fit contact mounted.

### DETAILED DESCRIPTION OF THE PREFERRED EMBODIMENTS

A detailed description will now be given of preferred embodiments of the present invention, with reference to the accompanying drawings.

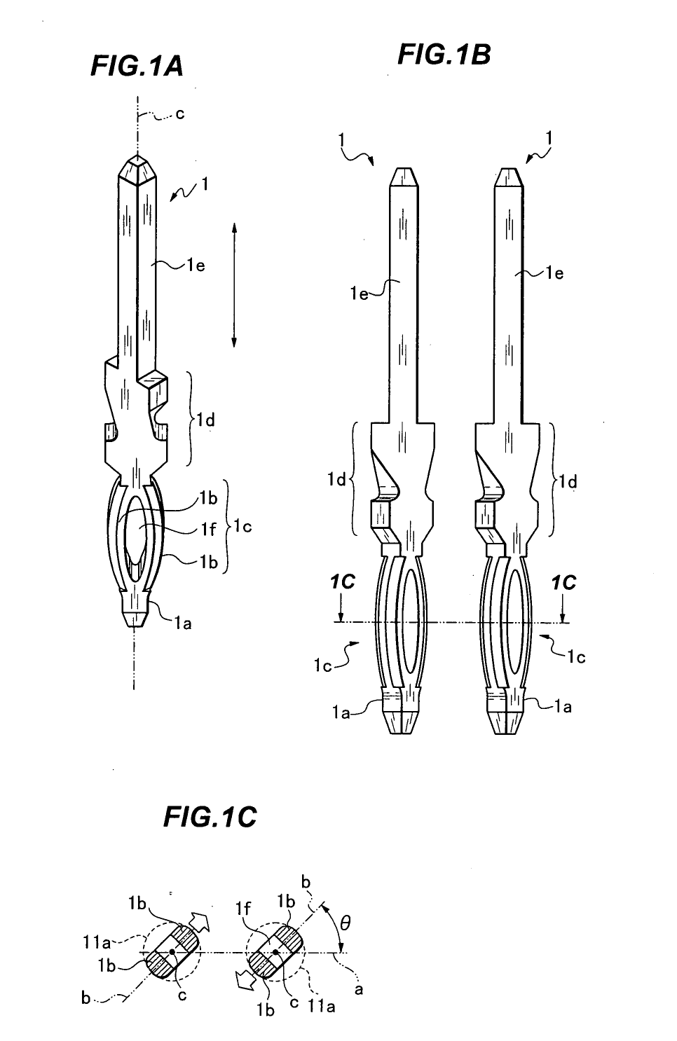

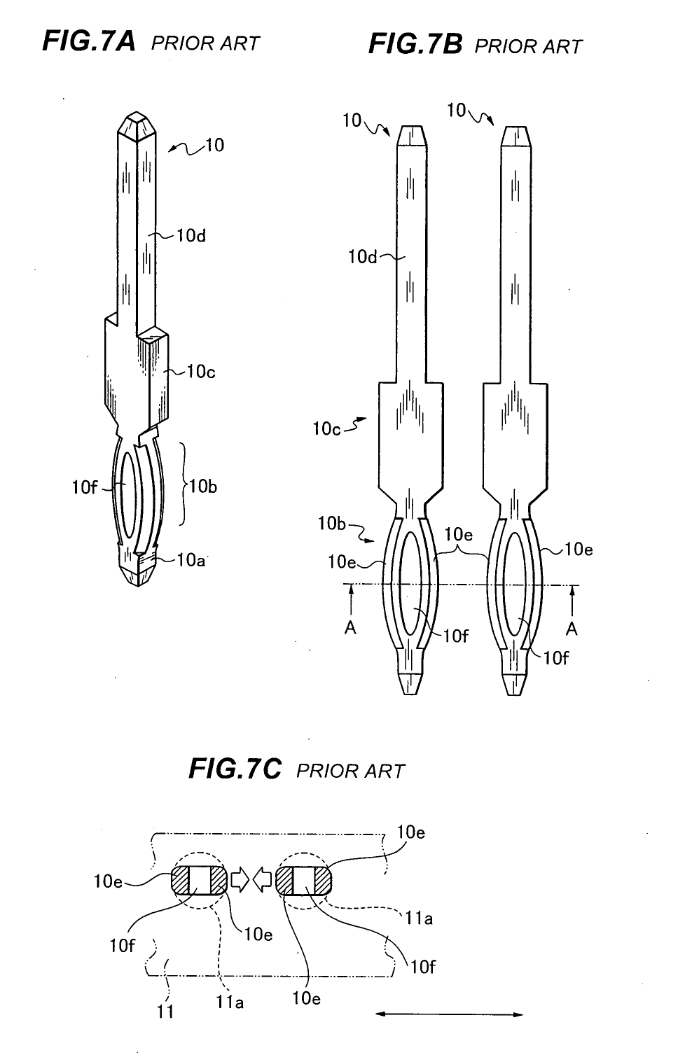

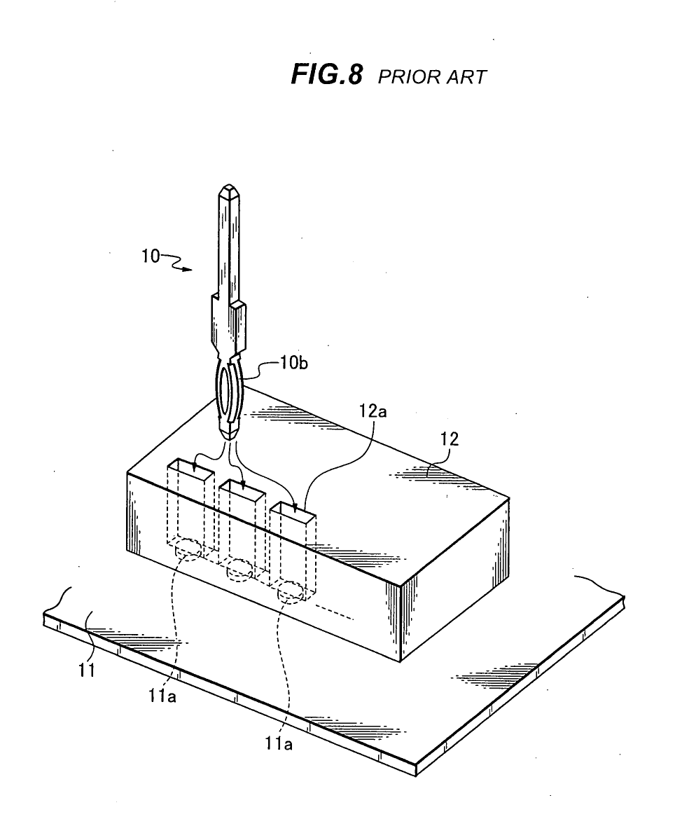

FIGS. 1A to 1C show a press-fit contact 1 according to a first embodiment of the present invention, which includes a steeple like introduction portion 1a for introducing the contact 1 into the through-hole 11a (see FIGS. 7 and 8) of the printed circuit board, a press-fit portion 1c adapted to have expanded portions 1b, 1b projecting along both sides in the shape of an arc while forming an elliptical slit 1f, a bulge portion 1d extended from the press-fit portion 1c and fixed in a fixing hole of an insulating housing, and a contact portion 1e extended from the bulge portion 1d. The press-fit portion 1c is press-fitted into the through-hole 11a of the printed circuit board.

The expanded portions 1b, 1b of the press-fit portion 1c projecting in the shape of an arc are twisted around their shaft center “c” in a circumferential direction as shown in FIG. 1C. As a result, when a plurality of press-fit contacts 1 is arranged in parallel in alignment with a line “a”, the expanded portions 1b, 1b of adjacent press-fit portions 1c are arranged in parallel with each other so as to be rotated by a twist angle θ with respect to the line “a”, such that their direction of expansion “b” is not in alignment with a line. In the present embodiment, the twist angle θ is approximately 45 degrees. In addition, the bulge portion 1d is twisted so that the press-fit portion 1c is rotated together with the twisted bulge portion 1d in plane with the rotation angle θ, and the expansion directions “b” of the expanded portions 1b, 1b are thus uniform in a long direction.

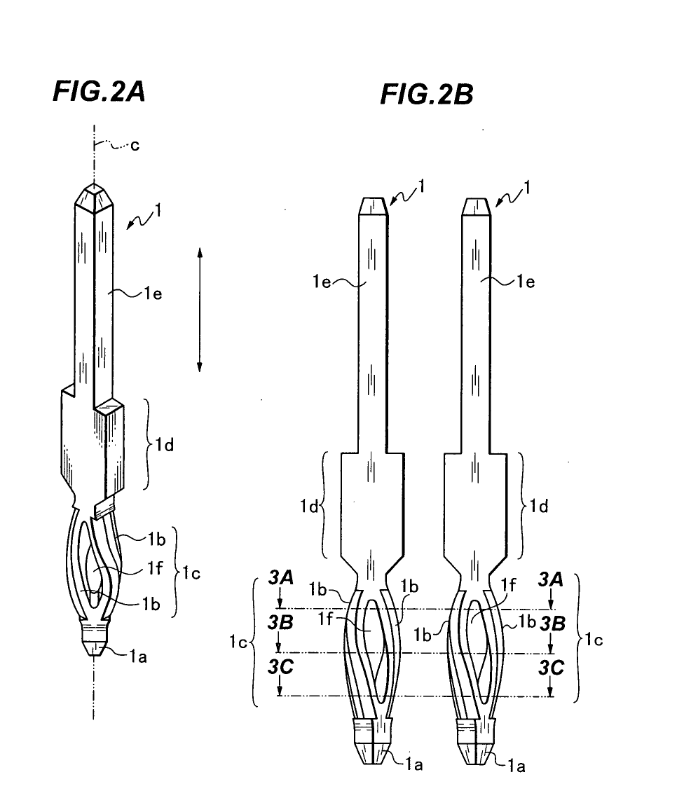

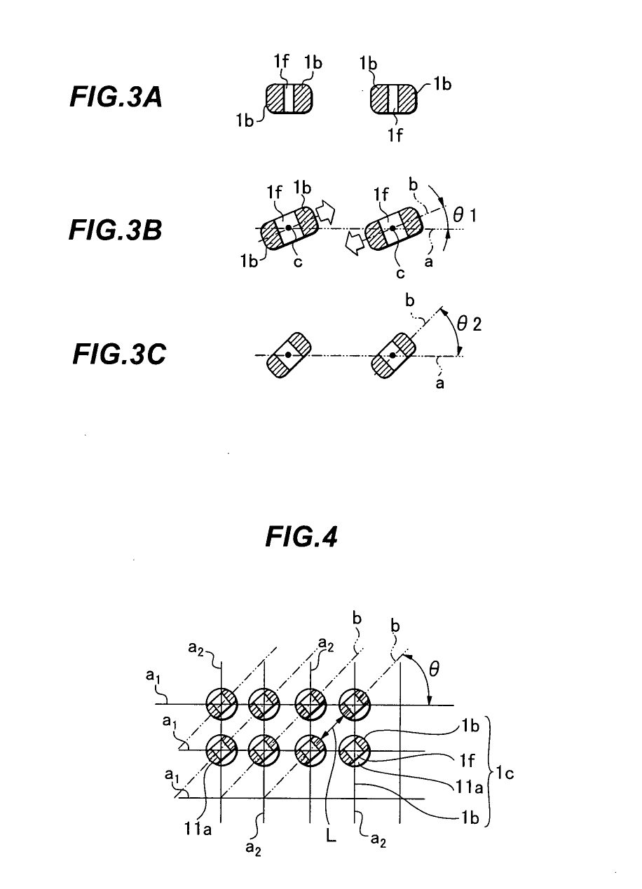

FIGS. 2A and 2B show a press-fit contact 1 according to a second embodiment, where the press-fit portion 1c itself is twisted. As shown in FIG. 2B, when three horizontal cross-sections 3A, 3B, and 3C are viewed vertically from the top, the press-fit contact 1 is not yet twisted in the cross-section 3A as shown in FIG. 3A, is rotated by an angle θ1 with respect to a line “a” in the cross-section 3B as shown in 3B, and is rotated by an angle θ2 (θ2>θ1) in the cross-section 3C as shown in 3C. More specifically, the expanded portions 1b, 1b of the press-fit portion 1c are twisted around the shaft center “c” in a circumferential direction to form a spiral shape.

When the press-fit contacts 1 according to the present invention formed as described above are press-fitted into the through-holes 11a of the printed circuit board 11, as shown in FIG. 4, the arrangement of the contacts in alignment with a line a1 brings the expansion directions “b” of the expanded portions 1b, 1b parallel to each other at an angle θ with respect to the line a1. The same applies to a line a2 perpendicular to the line a1. As a result, the concentration of contact pressure due to press-fitting of the press-fit portions 1c will not be caused between adjacent through-holes 11a, 11a.

In addition, when press-fit contacts are disposed in two or more rows, there will be through-holes 11a, 11a with the expansion directions b, b . . . in alignment as shown in FIG. 4. However, the arrangement of the through-holes 11a, 11a in the oblique direction makes the distance “L” therebetween substantially longer than the vertical and horizontal arrangement, that is, the arrangement of the expansion directions in alignment with the lines a1 and a2. Thus, the contact pressure is relaxed to eliminate a possibility of generation of damage to the board.

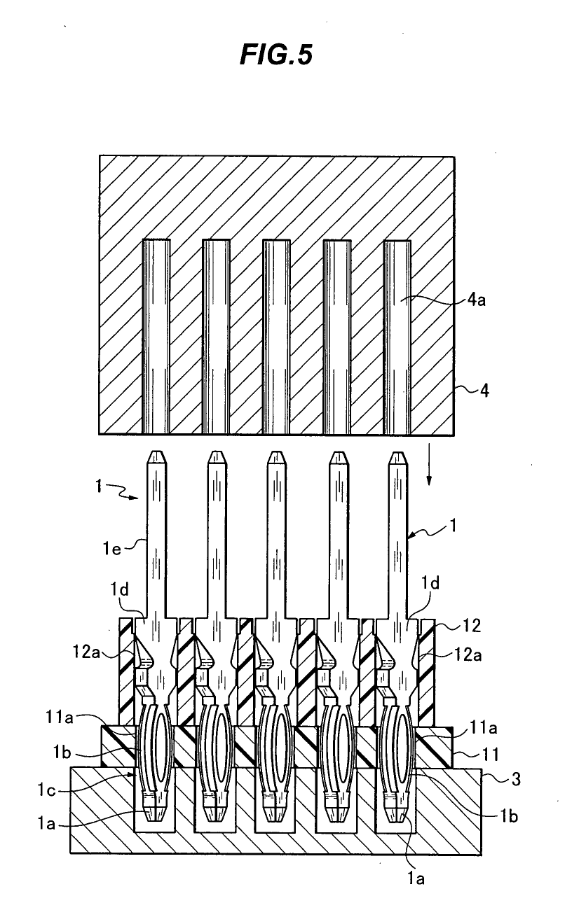

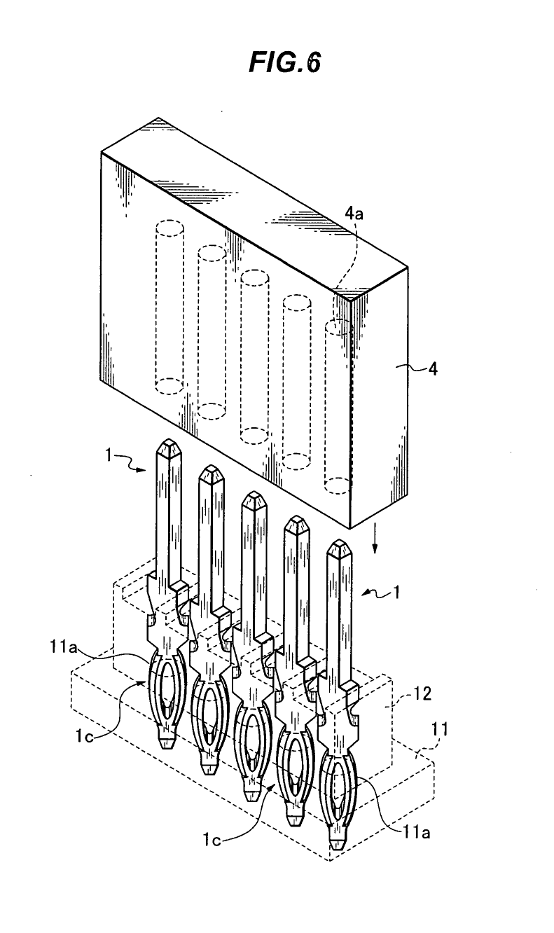

In order to press-fit the press-fit contacts 1 according to the present invention into a printed circuit board 11, as shown in FIGS. 5 and 6, the printed circuit board 11 and an insulating housing 12 are placed on a receiving jig 3, the press-fit contacts 1 are inserted into each of a plurality of fixing holes 12a, and a driving jig 4 with escape holes 4a, with each contact portion 1e put in an escape hole 4a, is placed on the press-fit contact 1 and pressed downward, causing the introduction portions 1a of the press-fit contacts 1 to pass through the through-holes 11a so to project downwardly, and the bulge portions 1d are thus press-fitted and fixed in the fixing holes 12a with the expanded portions 1b, 1b of the press-fit portions 1c strongly contacted against the walls of the through-holes 11a.

As many apparently widely different embodiments and variations of the present invention can be made without departing from the spirit and scope thereof, it is to be understood that the invention is not limited to the specific embodiments thereof and described herein, except as defined in the appended claims.

1. A press-fit contact comprising:
a bulge portion formed wide substantially at a center in a long direction of the press-fit contact,
a press-fit portion extending from one end of the bulge portion and projecting in an arc in a width direction of the press-fit contact,
a contact portion extending from other end of the bulge portion, and
an introduction portion extending from a distal end of the press-fit portion,
wherein a center portion of the press-fit portion in the long direction thereof, when adjacent press-fit contacts are provided in alignment with a line, having a direction of expansion that is not parallel to the line but is angled so as to be rotated about an axis of the center portion at a predetermined angle.

2. The press-fit contact according to claim 1, wherein the angle of the press-fit portion is formed by twisting the bulge portion.

3. The press-fit contact according to claim 1, wherein the angle of the press-fit portion is formed by twisting the press-fit portion itself.

4. The press-fit contact according to claim 2, wherein the bulge portion is made by forming a constricted portion with a vertical center thinned and twisting the constricted portion.

5. The press-fit contact according to claim 1, wherein the angle of rotation of the press-fit contact is approximately 45 degrees.

6. The press-fit contact according to claim 2, wherein the angle of rotation of the press-fit contact is approximately 45 degrees.

7. The press-fit contact according to claim 3, wherein the angle of rotation of the press-fit contact is approximately 45 degrees.

8. The press-fit contact according to claim 4, wherein the angle of rotation of the press-fit contact is approximately 45 degrees.
